(19) United States
(12) Patent Application Publication
(10) Pub. No.: US 2024/0096070 A1
(43) Pub. Date: Mar. 21, 2024

(54) METHODS AND SYSTEMS FOR GENERATING AND PROCESSING DIGITAL IMAGES ASSOCIATED WITH NON-FUNGIBLE TOKENS

(71) Applicant: WENEW, Inc., Los Angeles, CA (US)

(72) Inventors: Michael De Leon Figge, Los Angeles, CA (US); Randy Chia-Wei Chung, Bellevue, WA (US); Joseph Young Jim Kim, Cypress, CA (US)

(21) Appl. No.: 17/932,813

(22) Filed: Sep. 16, 2022

(51) Int. Cl. G06V 10/774; G06F 16/583; G06T 7/00; G06T 11/00; G06V 10/77; G06V 10/94

(52) U.S. Cl. CPC G06V 10/7747; G06F 16/583; G06T 7/0002; G06T 11/00; G06V 10/7715; G06V 10/94; G06T 2207/30168; G06V 2201/10

(57) ABSTRACT

A technique is directed to methods and systems for generating and processing digital images associated with non-fungible tokens. The image generation system can download a group of related images from a blockchain network and inspect the images to verify attributes and traits of the images meet a quality threshold. The system can generate and add a rarity item, such as a unique feature, to one or more of the images.

### BACKGROUND

Blockchain technology is used to transfer assets using tokens generated as part of a blockchain encryption process. An asset (e.g., an electronic coin, a blockchain-based good, a personal identifier, and so on) is represented by a chain of transactions that transfers ownership from one party to another party. To transfer ownership of an asset on a blockchain, a new transaction is generated and added to a stack of transactions in a block. The new transaction, which includes the public key of the new owner, is digitally signed by the owner with the owner's private key to transfer ownership to the new owner as represented by the new owner public key. Once the block is full, the block is “capped” with a block header that is a hash digest of all the transaction identifiers within the block. The block header is recorded as the first transaction in the next block in the chain, creating a mathematical hierarchy called a “blockchain.” To verify the current owner, the blockchain of transactions can be followed to verify each transaction from the first transaction to the last transaction. The new owner need only have the private key that matches the public key of the transaction that transferred the asset. The blockchain creates a mathematical proof of ownership in an entity represented by a security identity (e.g., a public key), which can be pseudo-anonymous.

The blockchain technology can maintain a distributed ledger of transactions. With a distributed ledger, a ledger of all the transactions for an asset is stored redundantly at multiple nodes (i.e., computers) of a blockchain network. The ledger at each node is stored as a blockchain. In a blockchain, the transactions are stored in the order that the transactions are received by the nodes. Each node in the blockchain network has a complete replica of the entire blockchain. The blockchain system also implements techniques to ensure that each node will store the identical blockchain, even though nodes can receive transactions in different orderings. To verify that the transactions in a ledger stored at a node are correct, the blocks in the blockchain can be accessed from oldest to newest, generating a new hash of the block and comparing the new hash to the hash generated when the block was created. If the hashes are the same, then the transactions in the block are verified. The blockchain system also implements techniques to ensure that it would be infeasible to change a transaction and regenerate the blockchain by employing a computationally expensive technique to generate a nonce that is added to the block when it is created. A blockchain ledger is sometimes referred to as an Unspent Transaction Output (“UTX0”) set because it tracks the output of all transactions that have not yet been spent.

### BRIEF DESCRIPTION OF THE DRAWINGS

FIG. 1 illustrates an image generation system for generating and processing digital images, in accordance with one or more embodiments of the present technology.

FIG. 2 is a flow diagram illustrating an example process of creating a digital image, in accordance with one or more embodiments of the present technology.

FIG. 3A is a flow diagram illustrating an example process of generating and processing digital images, in accordance with one or more embodiments of the present technology.

FIG. 3B is a flow diagram illustrating an example process of validating the authenticity of a digital image, in accordance with one or more embodiments of the present technology.

FIG. 4 illustrates an example of a process of creating a digital image, in accordance with one or more embodiments of the present technology.

FIG. 5 illustrates an example of a rarity item in an image, in accordance with one or more embodiments of the present technology.

FIG. 6 is a diagram illustrating a process for asset collection and preparation, in accordance with one or more embodiments of the present technology.

FIG. 7 is a block diagram illustrating an overview of devices on which some implementations can operate.

FIG. 8 is a block diagram illustrating an overview of an environment in which some implementations can operate.

FIG. 9 is a block diagram illustrating components which in some implementations can be used in a system employing the disclosed technology.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure are directed to methods and systems for generating and processing digital images associated with non-fungible tokens. The image generation system can include a user interface that is used to manage tokens (e.g., Non-Fungible tokens (NFTs)), assets associated with distributed ledger smart contracts, digital wallets, access token-based marketplaces, etc. NFTs are cryptographic, distributed ledger smart contracts and may be associated with digital art, in some cases with specific digital art as part of the token. Contrary to fungible tokens, each non-fungible token is unique. Generally, NFTs are often associated with the ownership of digital art. At least some embodiments are directed to assets (e.g., tangible and/or intangible assets) and services associated with the assets of the NFT and processes for creation and consumption of those assets. The assets can be artwork, such as digital artwork, stenciling, etc. An NFT is created (or “minted”) by interacting with a smart contract on the blockchain. A user can store an NFT(s), private keys, public keys, or any information in a digital wallet.

The image generation system can include an automated pipeline for generating and processing image files associated with an NFT(s). The image generation system can download a group of related images from a blockchain network. The system can inspect one or more of the images to verify attributes and traits of the images meet a quality/accuracy threshold. When the images meet the quality threshold, the system can execute a script to perform the verification steps on other images to provide confirmation that the images meet the quality threshold. For example, if there are thousands of images, the system executes a script to inspect/verify the attributes and traits of the thousands of images instead manually inspecting each image. The system can generate and add a rarity item(s) (e.g., unique object, feature, characteristic, etc.) to one or more of the inspected images. Once the items are finalized, the system can mint an NFT for each or groups of the images and store the NFTs on the blockchain network. In some implementations, the digital image is mapped onto a physical or digital asset, such as applying artwork onto a shirt or a shoe.

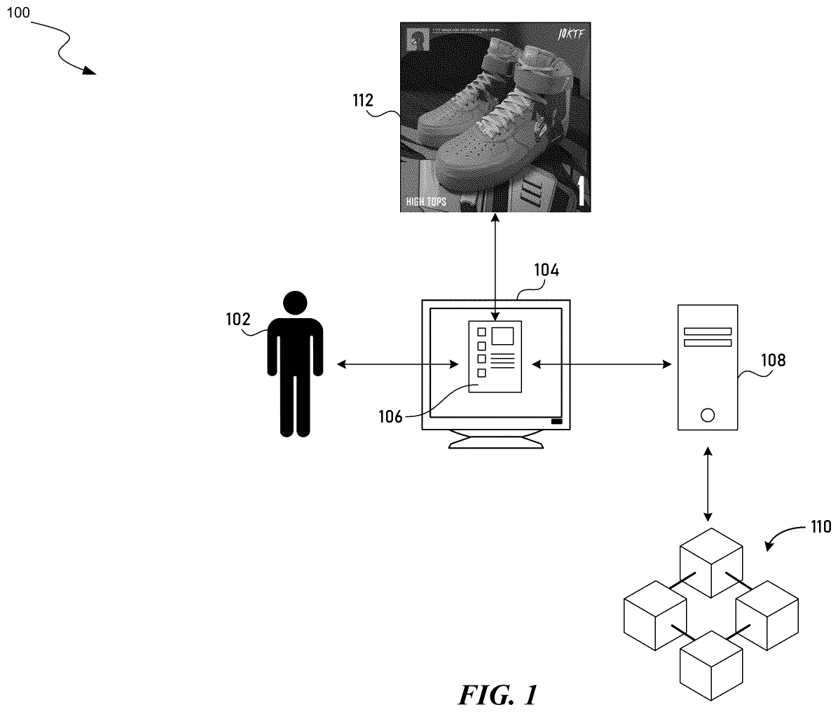

Several implementations are discussed below in more detail in reference to the figures. FIG. 1 illustrates an image generation system 100 for generating and processing images, in accordance with one or more embodiments of the present technology. User 102 via user interface 106 on device 104 (e.g., a smartphone, a personal computing device, etc.) can connect to server 108 to access the blockchain 110. User interface 106 can have buttons, filters, windows, tools (e.g., image editing tools, digital wallet tools, ledger tools, etc.) to manage operations. For example, the user interface 106 includes a digital marketplace interface configured to allow user 102 to purchase and manage tokens, such as NFTs. The user interface 106 can include blockchain information, a list of rights associated with smart contracts, token information, etc. User 102 can use the user interface 106 to generate, process and/or edit digital images, manage tokens, assets associated with distributed ledger smart contracts, digital wallets, etc. For example, user 102 can purchase an NFT through the digital marketplace on the user interface 106. Upon purchase of the NFT, the user interface 106 submits the information to a server 108. The server 108 can initiate function calls to the NFT smart contract on the blockchain 110 to transfer the NFT to the buyer's wallet, in exchange of a payment (e.g., blockchain payment, such as crypto currency).

In some implementations, system 100 includes an automated pipeline for processing image files (e.g., image 112) associated with an NFT(s). Device 104 can retrieve/download images (e.g., identical, similar, or different images) from the blockchain 110. User 102, via interface 106, or a script operating on device 104, can inspect the image to verify attributes (e.g., lighting, digital to physical mapping, color density, texture quality, etc.) of the image meet a quality/accuracy threshold. User 102 can identify image traits that are unique to the image. In some implementations, the user performs a preliminary fit of the image on an asset. For example, the image is fitted, via interface 106, on models of clothes, shoes, or any object to verify that the image can be mapped onto the object and the appearance meets a quality threshold. When the image meets a quality threshold, device 104 can execute a script to perform the verification steps on other images to provide confirmation that the images meet a quality threshold. For example, if there are thousands of identical or similar images, system 100 can execute a script to inspect/verify the attributes and traits of the thousands of images instead of the user 102 inspecting each of the thousands of images.

System 100 can generate rarity items to add to one or more of the inspected images. Adding a rarity item to an image can make the image unique among other images. For example, in a thousand images (e.g., of a rainbow), only five of the thousand images have a rarity item (e.g., pot of gold under the rainbow) added to the five images to make the five images unique among the thousand images. The system 100 can mint an NFT for each or groups of the images and the NFTs can be added to the blockchain 110.

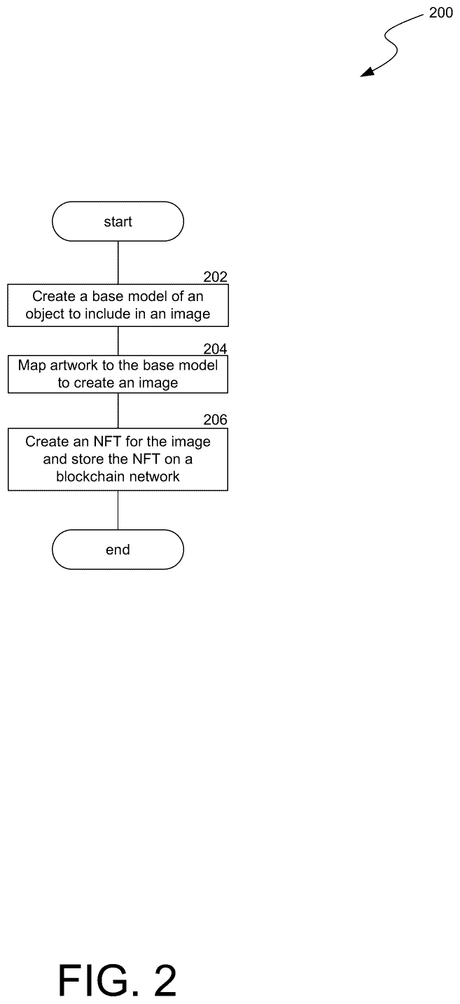

FIG. 2 is a flow diagram illustrating an example process 200 of creating a digital image, in accordance with one or more embodiments of the present technology. In some implementations, process 200 is triggered by a user powering on a device, connecting to a blockchain network, downloading an image(s), or the user downloading an application on a device to generate and process images. In various implementations, some, or all of process 200 is performed locally on the user device or performed by cloud-based device(s) that can provide/support the image generation system.

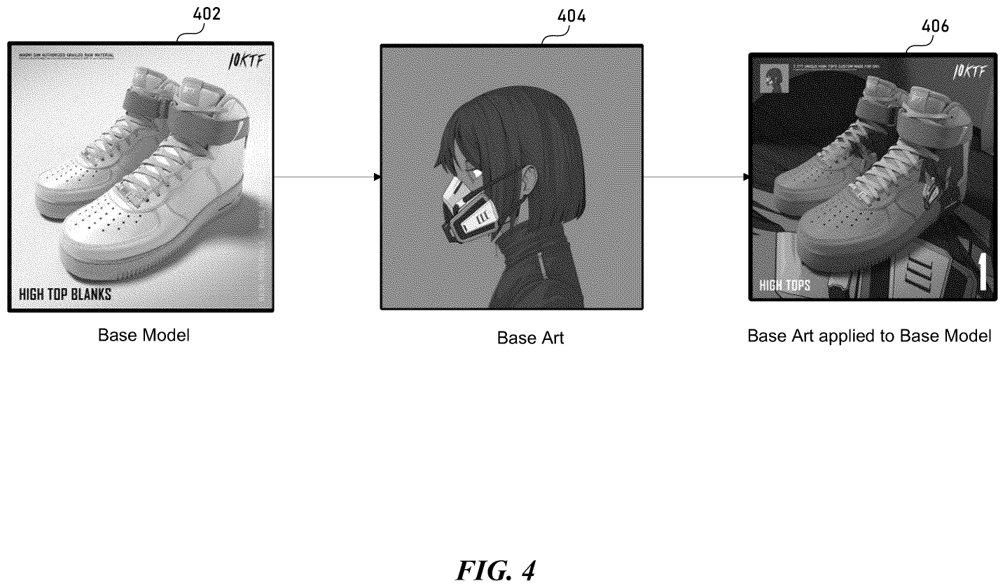

At block 202, process 200 creates a base model of an object to include in an image. The base model can include high-fidelity textures and physical based rendering (PBR) materials with the channels of diffuse color, metallic materials, specular roughness, bump map, normal map, and/or masks to aid in the isolation of key features. Process 200 can utilize geometry mapping to reduce calculations on the render time of the base model. FIG. 4 illustrates a base model 402 of an object (e.g., shoes) in an image.

At block 204, process 200 maps/applies base art (e.g., digital artwork) to the base model to create an image. Process 200 can map the textures of the base art to the base model with a neutral diffuse color and replace the diffuse color by the base art image file. For example, in FIG. 4, base art 404, is mapped to the shoe (illustrated in base model 402) in a way that produces a layout and color scheme. In terms of layout, the base art 404 is mapped on the shoe to be legible. Image 406 illustrates the base art 404 applied to the base model 402. Process 200 can include a shader network to sample from the original image (e.g., profile picture (PFP) image) in creating complementary colors for the various trim and detailing on the product itself. At block 206, process 200 creates an NFT for the image and stores the NFT on a blockchain network.

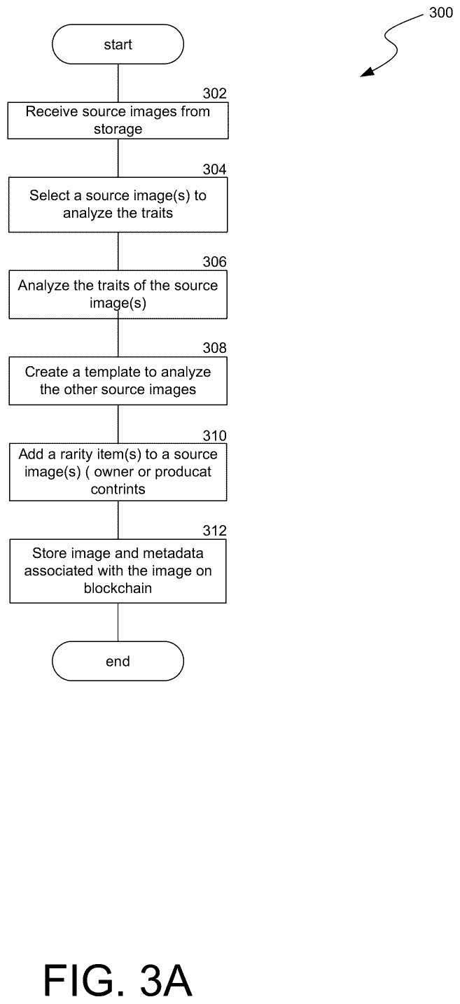

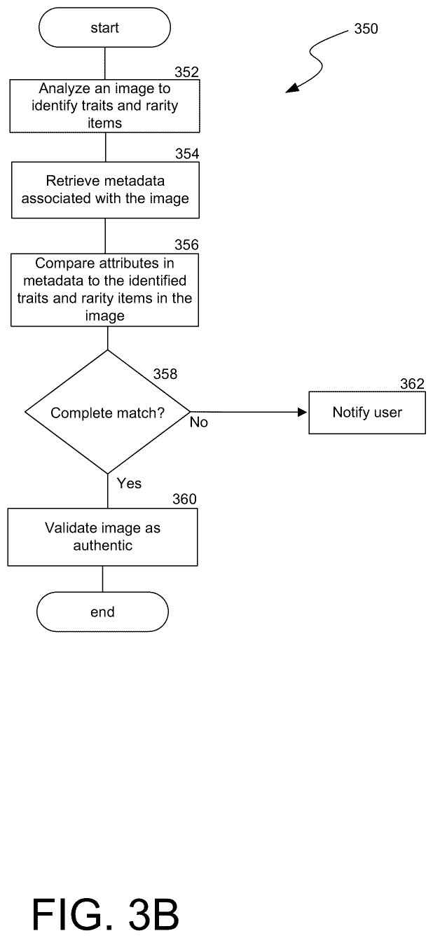

FIG. 3A is a flow diagram illustrating an example process 300 of generating and processing digital images, in accordance with one or more embodiments of the present technology. In some implementations, process 300 is triggered by a user powering on a device, connecting to a blockchain network, downloading an image(s), or the user downloading an application on a device to generate and process images. In various implementations, some or all of process 300 is performed locally on the user device or performed by cloud-based device(s) that can provide/support the image generation system.

At block 302, process 300 receives source images from a storage source. Process 300 can download the source images from a blockchain related storage system (e.g., peer-to-peer storage network). At block 304, process 300 selects a source image(s) to analyze and identify the traits of the image.

At block 306, process 300 analyzes the traits of the selected source image(s). Process 300 can verify the artistic fidelity of the selected source image(s). For example, process 300 analyzes the lighting, color density, texture, or any traits/features of the image to ensure that the traits meet a quality threshold. The quality threshold can be determined by the owner of the image, artist of the image, or be a standard artistic metric. Traits/features of the image may likewise be determined by the owner of the image, artist of the image, or through analysis of unique characteristics of the source image (e.g., an earring worn by a character). Unique traits/features may be determined within the context of a single group of images (e.g., pictures of dogs), or they may be determined by comparing against groups of images (e.g., pictures of pets, which include pictures of dogs, cats, and birds). This process may also accept user input to guide what characteristics to weigh more heavily. For example, in a collection of images where the artistic style has been determined to be more abstract, process 300 may select for traits which exhibit certain characteristics, such as being particularly jagged, or conversely, more rounded.

When process 300 determines that the selected source image(s) meet the quality threshold, at block 308, process 300 creates a template/script to analyze the other source images in an automated process. Process 300 can execute a script to analyze the other source images. For example, if there a thousands of source images, process 300 can analyze all the source images by executing the script without requiring a user to manually verify each image. In some implementations, process 300 can perform a spot check on a number of random source images to analyze the traits. If an image does not meet the quality threshold, process 300 can edit the image to meet the quality threshold or discard the image.

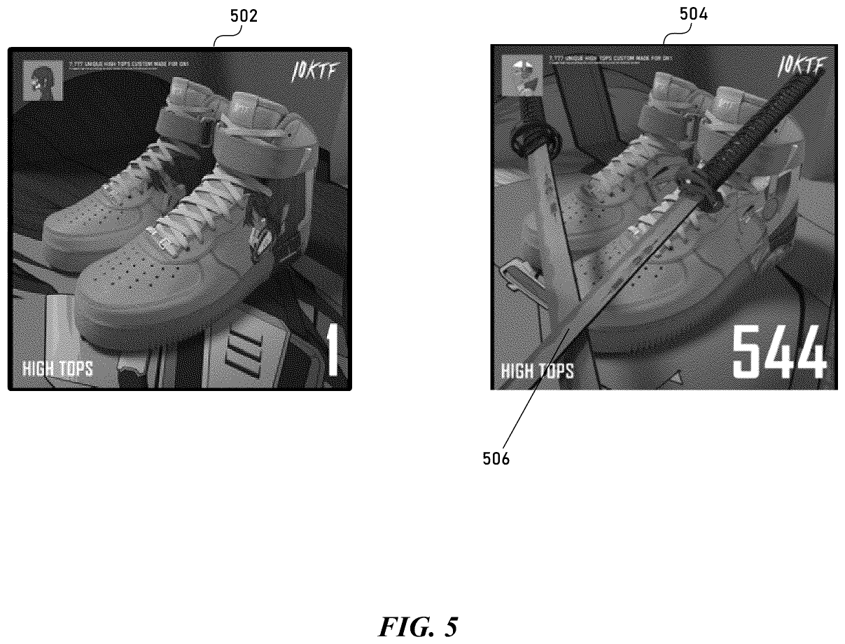

At block 310, process 300 adds a rarity item(s) to a source image(s). A rarity item can include a unique object, feature, characteristic, or any additional item that distinguishes an image from the source images. Rarity items can be randomly generated traits presented as additional scene objects in an image. Process 300 can execute a script to apply rarity items to a predetermined or random number of the source images. In some cases, the rarity items are related to the subject/topic of the source image. For example, for a thousand source images of cats, process 300 can add a ball of yarn to ten of the images and two balls of yarn to five of the images. The rarity items may also be entirely arbitrary, such as being randomly selected from a list of possible items. The specific nature of a rarity item may vary between collections of images, for example, in images of cats, the rarity item is a ball of yarn, while in images of dogs, the rarity item is a bone. The rarity items may also be consistently applied across all images (e.g., both images of dogs and cats having a collar as the rarity item). FIG. 5 illustrates an example of a rarity item 506 in image 504, which is added to differentiate from a source image 502, in accordance with one or more embodiments of the present technology. For example, rarity item 506 (e.g., two swords) makes image 504 unique from source image 502. Process 300 can determine the type of rarity item based on product constraints or image owner constraints. For example, a brand of shoe or image owner preference can determine whether a rarity item or type of rarity item is added to the image. Rarities may also be specified in terms of tiers (e.g., common, uncommon, rare, epic, etc.) For each tier, the number or specific character of the item may change, such as a single sword in an uncommon version of the image, and two swords in a rare version of the same image. Each tier of rarity may also have individually specified rates of occurrences, for example, 10% of all items in one collection are common, while in another collection only 5% of the items are common. Rarity tiers may also have different rates of occurrence in a single collection, for example amongst all cat images, 50% are common, 30% uncommon, 15% rare, and 5% epic. In some implementations, each tier of rarity has its own rarity item added to the image (e.g., one sword in common images, two in uncommon images, three in rare, etc.). The specific distribution of which images belong to which rarity tier may be algorithmically generated, or they may be manually specified. For the case where they are algorithmically generated, some implementations may choose to use a true random number generator, while others may choose to use a pseudorandom number generator (including seeded pseudorandom number generators). In some implementations, this process may normalize rarity item occurrences across collections. For example, 100 rare items occur in collection A, and 100 rare items occur in collection B, C, etc. In some implementations, process 300 creates a CSV file to instruct a device to add rarity items to one or more source images.

At block 312, process 300 can store the created images and metadata associated with the created images in a blockchain related storage system. The metadata for each image includes data related to the image, such as image identification number, trait information, rarity item information, etc. The metadata can function as the “source of truth” on what features, characteristics, and rarity items are in each image. For example, the metadata associated with an image indicates whether the image includes any rarity items, what the rarity item are, and where the rarity items are located in the image. In some implementations, process 300 creates an NFT for the image and/or metadata and stores the NFT on a blockchain network. This metadata may be generated by the same script that determines what rarity item to apply to each item, or it may be generated by another script that is run after the rarity items are determined.

FIG. 3B is a flow diagram illustrating an example process 350 of validating the authenticity of a digital image, in accordance with one or more embodiments of the present technology. In some implementations, process 350 is triggered by a user powering on a device, connecting to a blockchain network, downloading an image(s), purchasing an NFT associated with an image, generating a digital image, or the user downloading an application on a device to validate images. In various implementations, some or all of process 350 is performed locally on the user device or performed by cloud-based device(s) that can provide/support the image generation system.

At block 352, process 350 analyzes an image to identify the traits and rarity items in the image. Process 350 can scan the image to collect image data and analyze the image data to identify the traits (e.g., objects, items, characteristics, coloring, textures, contorting, location of the features/objects in the image, etc.) and rarity items in the image. At block 354, process 350 can retrieve metadata associate with the image from a storage location (e.g., blockchain storage network, NFT, cloud storage, etc.). The metadata can include attributes of the image, such as rarity item information in the image, trait information, and any data associate with the image.

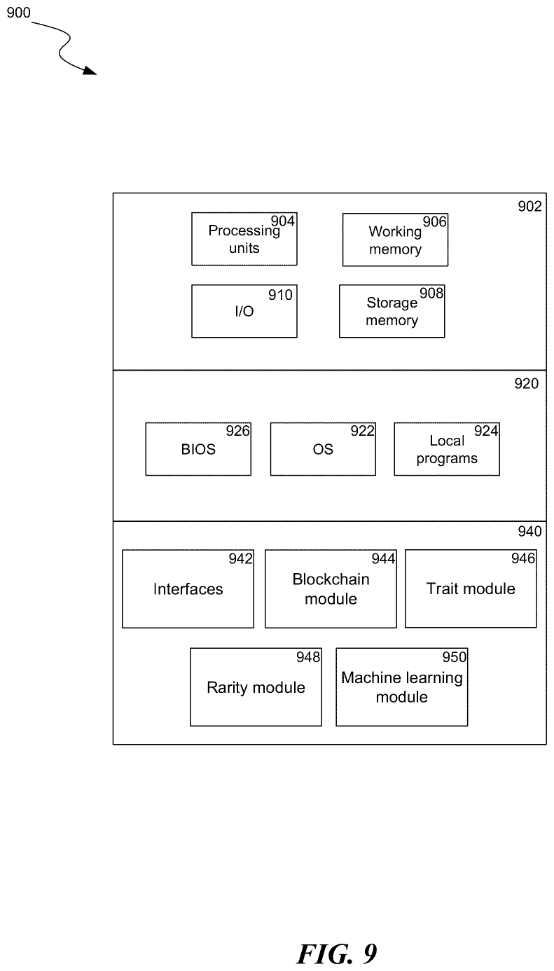

At block 356, process 350 can compare the metadata attributes to the identified traits and rarity items. In some implementations, process 350 utilizes machine learning to compare the metadata attributes to the identified traits and rarity items. Additional details on the machine learning are described in FIG. 9. At block 358, process 350 determines whether there is a complete match between the metadata attributes and the identified traits and rarity items of the image. If there is a complete match, at block 360, process 350 validates the image as authentic. If there is not a complete match, at block 362, process 350 sends a notification to alert the user (e.g., owner of the NFT associated with the image) of the mismatch between the metadata attributes and what was identified in the image.

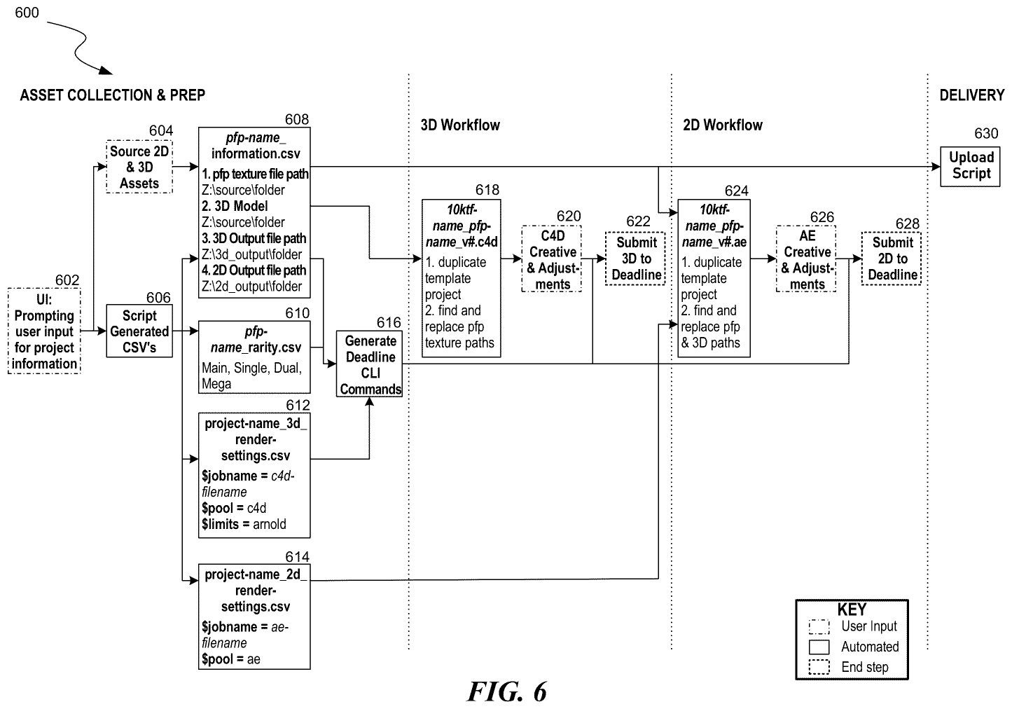

FIG. 6 is a diagram illustrating a process 600 for asset collection and preparation, in accordance with one or more embodiments of the present technology.

At block 602, process 600 prompts a user via a user interface for input regarding project information. At block 604, process 600 collects image source information for 2D and 3D assets for the project information of block 602. At block 606, process 600 executes a script to generate CSV files with the project information to generate and process images. At block 608, process 600 processes a CSV file for the PFP name information (e.g., PFP texture file path, 3D model, 3D output file path, 2D output file path, etc.) and the result feeds into blocks 616, 618, and 630. Block 608 may generate a number of assets that are passed to later blocks (e.g., 3D models, 2D images, etc.).

At block 610, process 600 processes a CSV file for the PFP rarity name (e.g., main, single, dual, or mega rarity) and the result feeds into block 616. At block 612, process 600 processes a CSV file for the project name and 3D rendering settings (e.g., job name, pool, limits, etc.) and the result feeds into block 616. At block 614, process 600 processes a CSV file for the project name and 2D rendering settings (e.g., job name, pool, etc.) and the result feeds into block 624. At block 616, process 600 generates deadline CLI commands with input from blocks 608, 610, and 612, with the result feeding into block 628. Each of these blocks may likewise generate a number of assets that are passed to later blocks (e.g., rendering settings files, scripts with deadline CLI commands, etc.).

At block 618, process 600 duplicates the template project and finds and replaces the PFP texture paths. At block 620, process 600 creates image attributes and adjusts features of the images with the result of block 618. At block 622, process 600 receives input from blocks 620 and 616 and submits the 3D data by executing the deadline command. The deadline script may execute any number of commands as part of its processing pipeline. At block 624, process 600, with input from blocks 608 and 614, duplicates the template project and finds and replaces PFP and 3D paths. At block 626, process 600 receives input from block 624 and makes creative alterations and adjustments to the data. At block 628, process 600 receives input from blocks 626 and 616 and submits the 2D data by executing the deadline command. At block 630, process 600 uploads the script to the network (e.g., blockchain network). Blocks 602, 604, 620, and 626 illustrate user input steps of process 600. Blocks 606, 608, 610, 612, 614, 616, 618, 624, and 630 illustrate automated steps of process 600. Blocks 622 and 626 illustrate end steps of process 600.

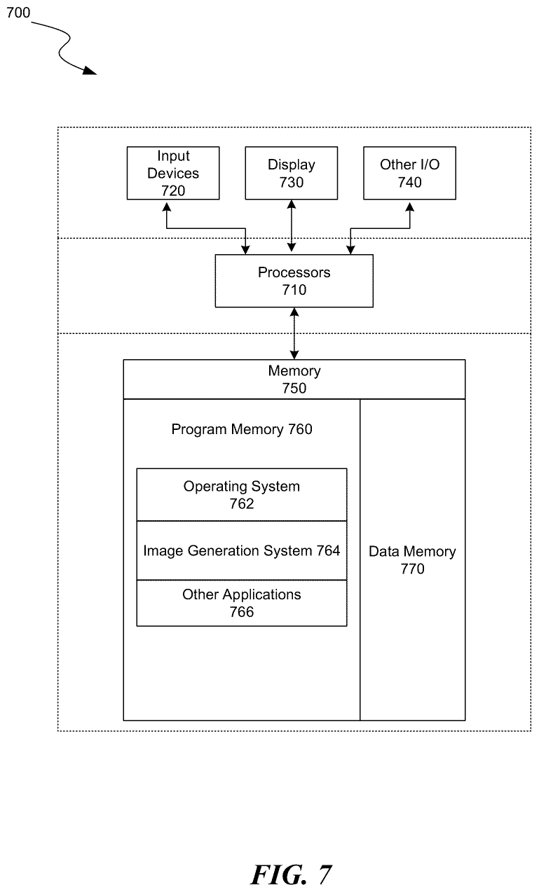

FIG. 7 is a block diagram illustrating an overview of devices on which some implementations of the disclosed technology can operate. The devices can comprise hardware components of a device 700 that manage entitlements within a real-time telemetry system. Device 700 can include one or more input devices 720 that provide input to the processor(s) 710 (e.g., CPU(s), GPU(s), HPU(s), etc.), notifying it of actions. The actions can be mediated by a hardware controller that interprets the signals received from the input device and communicates the information to the processors 710 using a communication protocol. Input devices 720 include, for example, a mouse, a keyboard, a touchscreen, an infrared sensor, a touchpad, a wearable input device, a camera- or image-based input device, a microphone, or other user input devices.

Processors 710 can be a single processing unit or multiple processing units in a device or distributed across multiple devices. Processors 710 can be coupled to other hardware devices, for example, with the use of a bus, such as a PCI bus or SCSI bus. The processors 710 can communicate with a hardware controller for devices, such as for a display 730. Display 730 can be used to display text and graphics. In some implementations, display 730 provides graphical and textual visual feedback to a user. In some implementations, display 730 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 740 can also be coupled to the processor, such as a network card, video card, audio card, USB, firewire or other external device, camera, printer, speakers, CD-ROM drive, DVD drive, disk drive, or Blu-Ray device.

In some implementations, the device 700 also includes a communication device capable of communicating wirelessly or wire-based with a network node. The communication device can communicate with another device or a server through a network using, for example, TCP/IP protocols. Device 700 can utilize the communication device to distribute operations across multiple network devices.

The processors 710 can have access to a memory 750 in a device or distributed across multiple devices. A memory includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 750 can include program memory 760 that stores programs and software, such as an operating system 762, image generation system 764, and other application programs 766. Memory 750 can also include data memory 770, storing throttle data, user data, machine data, transmission data, sensor data, device data retrieval data, management data, customer information data, configuration data, settings, user options or preferences, etc., which can be provided to the program memory 760 or any element of the device 700.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

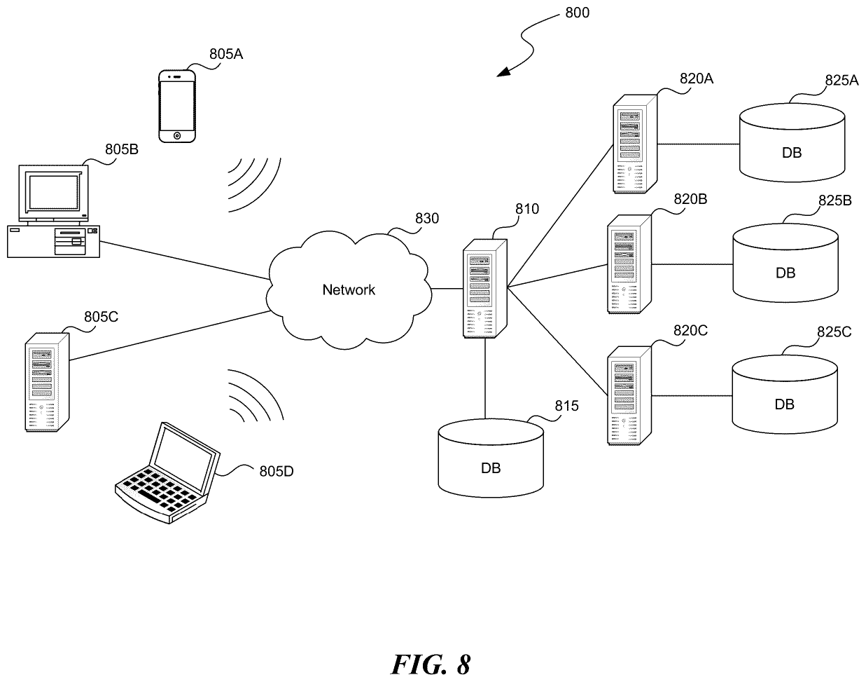

FIG. 8 is a block diagram illustrating an overview of an environment 800 in which some implementations of the disclosed technology can operate. Environment 800 can include one or more client computing devices 805A-D, examples of which can include device 700. Client computing devices 805 can operate in a networked environment using logical connections through network 830 to one or more remote computers, such as a server computing device 810.

In some implementations, server 810 can be an edge server which receives client requests and coordinates fulfillment of those requests through other servers, such as servers 820A-C. Server computing devices 810 and 820 can comprise computing systems, such as device 700. Though each server computing device 810 and 820 is displayed logically as a single server, server computing devices can each be a distributed computing environment encompassing multiple computing devices located at the same or at geographically disparate physical locations. In some implementations, each server 820 corresponds to a group of servers.

Client computing devices 805 and server computing devices 810 and 820 can each act as a server or client to other server/client devices. Server 810 can connect to a database 815. Servers 820A-C can each connect to a corresponding database 825A-C. As discussed above, each server 820 can correspond to a group of servers, and each of these servers can share a database or can have their own database. Databases 815 and 825 can warehouse (e.g. store) information such as implement data, machine data, sensor data, device data, notification data, measurement, and alert data. Though databases 815 and 825 are displayed logically as single units, databases 815 and 825 can each be a distributed computing environment encompassing multiple computing devices, can be located within their corresponding server, or can be located at the same or at geographically disparate physical locations.

Network 830 can be a local area network (LAN) or a wide area network (WAN), but can also be other wired or wireless networks. Network 830 may be the Internet or some other public or private network. Client computing devices 805 can be connected to network 830 through a network interface, such as by wired or wireless communication. While the connections between server 810 and servers 820 are shown as separate connections, these connections can be any kind of local, wide area, wired, or wireless network, including network 830 or a separate public or private network.

FIG. 9 is a block diagram illustrating components 900 which, in some implementations, can be used in a system employing the disclosed technology. The components 900 include hardware 902, general software 920, and specialized components 940. As discussed above, a system implementing the disclosed technology can use various hardware including processing units 904 (e.g. CPUs, GPUs, APUs, etc.), working memory 906, storage memory 908 (local storage or as an interface to remote storage, such as storage 815 or 825), and input and output devices 910. In various implementations, storage memory 908 can be one or more of: local devices, interfaces to remote storage devices, or combinations thereof. For example, storage memory 908 can be a set of one or more hard drives (e.g. a redundant array of independent disks (RAID)) accessible through a system bus or can be a cloud storage provider or other network storage accessible via one or more communications networks (e.g. a network accessible storage (NAS) device, such as storage 815 or storage provided through another server 820). Generally, memory 908 can include any device, mechanism, or populated data structure used for storing information. In accordance with some embodiments of the present disclosures, memory 908 can encompass, but is not limited to, any type of volatile memory, nonvolatile memory, and dynamic memory. For example, memory 908 can be random access memory, memory storage devices, optical memory devices, magnetic media, floppy disks, magnetic tapes, hard drives, SIMMs, SDRAM, RDRAM, DDR, RAM, SODIMMs, EPROMs, EEPROMs, compact discs, DVDs, and/or the like. In accordance with some embodiments, memory 908 may include one or more disk drives, flash drives, one or more databases, one or more tables, one or more files, local cache memories, processor cache memories, relational databases, flat databases, and/or the like. In addition, those of ordinary skill in the art will appreciate many additional devices and techniques for storing information that can be used as memory 908. In some example aspects, memory 908 may store at least one database containing network information (e.g., ledgers, private/public keys, etc.). Components 900 can be implemented in a client computing device such as client computing devices 805 or on a server computing device, such as server computing device 810 or 820.

General software 920 can include various applications including an operating system 922, local programs 924, and a basic input output system (BIOS) 926. Specialized components 940 can be subcomponents of a general software application 920, such as local programs 924. Specialized components 940 can include blockchain module 944, trait module 946, rarity module 948, machine learning module 950, and components which can be used for providing user interfaces (e.g., user interface 106), transferring data, and controlling the specialized components, such as interfaces 942. In some implementations, components 900 can be in a computing system that is distributed across multiple computing devices or can be an interface to a server-based application executing one or more of specialized components 940. Although depicted as separate components, specialized components 940 may be logical or other nonphysical differentiations of functions and/or may be submodules or code-blocks of one or more applications.

In some embodiments, the blockchain module 944 is configured to provide blockchain functionality for the system. The blockchain module 944 allows for the creation of a new block for a new/existing blockchain distributed ledger, hashing of the new block, and addition of the new block to the user's private blockchain and distributed ledger. Examples of hash functions include different types of Secure Hash Algorithms (SHA-1, SHA-2, or SHA-3) or a Jenkins hash function. The blockchain module 944 can manage a plurality of public blockchains, private blockchains, and/or other distributed ledgers for users. In some implementations, the privacy of each user's blockchain(s) can be ensured because each user maintains an individual blockchain and/or ledger for the user's data. In other implementations, transactions include a public key that matches a private key associated with the user. In these implementations, while the transactions are added to a public ledger, details of the transactions can only be accessed when the private key is used, ensuring user data privacy.

Blockchain module 944 is further configured to add new blocks to the blockchain when a user connects a device to the network, purchases an NFT, generates or processes an image, or subscribes to the image generation service. For instance, if a user initiates a transaction by generating an image and/or storing an NFT associated with the image on the blockchain, the transaction may be recorded on a blockchain so other nodes participating in the system can successfully and accurately validate the user's transaction.

In some embodiments, the trait module 946 is configured to analyze the traits of an image. The trait module 946 can verify the artistic fidelity of the image by analyzing the lighting, color, color density, texture, or any characteristics/features of the image to ensure that the traits meet a quality threshold. The quality threshold can be determined by the owner of the image, artist of the image, or be a standard artistic metric.

In some embodiments, the rarity module 948 is configured to add a rarity item(s) to an image. A rarity item can include a unique object, feature, characteristic, or any additional item that distinguishes an image from another image. Rarity items can be randomly generated traits presented as additional scene objects in an image. Rarity module 948 can execute a script to apply rarity items to a predetermined or random number of the source images. In some cases, the rarity items are related to the subject of the image. The rarity module 948 can determine a type of rarity item based on a product the image will be applied on or constraints specified by the image owner.

In some embodiments, the machine learning module 950 is configured to validate the authenticity of an image by comparing metadata associated with an image to attributes (e.g., rarity items, traits, etc.) in the image. The machine learning module 950 may be configured to validate an image based on at least one machine-learning algorithm trained on at least one dataset of identified information of comparing metadata associated with an image to attributes in the image. The at least one machine-learning algorithms (and models) may be stored locally at databases and/or externally at databases. User devices may be equipped to access these machine learning algorithms and intelligently identify when to compare metadata associated with an image to attributes in the image based on at least one machine-learning model that is trained on a dataset of validated images. As described herein, a machine-learning (ML) model may refer to a predictive or statistical utility or program that may be used to determine a probability distribution over one or more-character sequences, classes, objects, result sets or events, and/or to predict a response value from one or more predictors. A model may be based on, or incorporate, one or more rule sets, machine learning, a neural network, or the like. In examples, the ML models may be located on the client device, service device, a network appliance (e.g., a firewall, a router, etc.), or some combination thereof. The ML models may process user information databases and other data stores to determine how and when to compare metadata associated with an image to attributes in the image.

Based on the validation information, metadata and image information from user information databases and platforms and other user data stores, at least one ML model may be trained and subsequently deployed to automatically validate the authenticity of an image by comparing metadata associated with an image to attributes in the image. The trained ML model may be deployed to one or more devices. As a specific example, an instance of a trained ML model may be deployed to a server device and to a client device which communicate with a machine. The ML model deployed to a server device may be configured to be used by the client device when, for example, the client device is connected to the Internet. Conversely, the ML model deployed to a client device may be configured to be used by the client device when, for example, the client device is not connected to the Internet. In some instances, a client device may not be connected to the Internet but still configured to receive satellite signals with image information, such as specific NFT information. In such examples, the ML model may be locally cached by the client device.

### CONCLUSION

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

Reference in this specification to “implementations” (e.g. “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

Unless explicitly excluded, the use of the singular to describe a component, structure, or operation does not exclude the use of plural such components, structures, or operations. As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

As used herein, the expression “at least one of A, B, and C” is intended to cover all permutations of A, B and C. For example, that expression covers the presentation of at least one A, the presentation of at least one B, the presentation of at least one C, the presentation of at least one A and at least one B, the presentation of at least one A and at least one C, the presentation of at least one B and at least one C, and the presentation of at least one A and at least one B and at least one C.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A computing system comprising:
at least one processor; and
at least one memory storing instructions that, when executed by the at least one processor, cause the computing system to perform a process for generating digital images containing rarity items, the process comprising:
receiving, from a blockchain storage location, an image illustrating at least one object;
analyzing at least one trait of the image to determine the image meets a quality threshold;
in response to the image meeting the quality threshold, adding at least one rarity item to the image; and
storing metadata, associated with the image illustrating the at least one object and the at least one rarity item, in a non-fungible token (NFT) governed by a smart contract.

2. The computing system of claim 1, wherein the process further comprises:
collecting one or more features from the image;
comparing the one or more features to one or more attributes in the metadata associated with the image; and
in response to the one or more features matching the one or more attributes in the metadata, establishing authenticity that the image is related to the NFT governed by the smart contract.

3. The computing system of claim 2, wherein the authenticity is established by at least one machine-learning algorithm, wherein the at least one machine-learning algorithm is trained based on at least one dataset associated with a previous image authenticity data source.

4. The computing system of claim 1, wherein the process further comprises:
generating a script to analyze two or more images for the at least one trait; and
executing the script to identify the at least one trait in the two or more images.

5. The computing system of claim 1, wherein the process further comprises:
generating a script to add the at least one rarity item to two or more images; and
executing the script to add the at least one rarity item to the two or more images.

6. The computing system of claim 1, wherein the process further comprises:
creating the image based on an artwork being applied to a model of the at least one object.

7. The computing system of claim 1, wherein the at least one rarity item is related to the at least one object illustrated in the image.

8. A method for generating digital images containing rarity items, the method comprising:
receiving, from a blockchain storage location, an image illustrating at least one object;
analyzing at least one trait of the image to determine the image meets a quality threshold;
in response to the image meeting the quality threshold, adding at least one rarity item to the image; and
storing metadata, associated with the image illustrating the at least one object and the at least one rarity item, in a non-fungible token (NFT) governed by a smart contract.

9. The method of claim 8, further comprising:
collecting one or more features from the image;
comparing the one or more features to one or more attributes in the metadata associated with the image; and
in response to the one or more features matching the one or more attributes in the metadata, establishing authenticity that the image is related to the NFT governed by the smart contract.

10. The method of claim 9, wherein the authenticity is established by at least one machine-learning algorithm, wherein the at least one machine-learning algorithm is trained based on at least one dataset associated with a previous image authenticity data source.

11. The method of claim 8, further comprising:
generating a script to analyze two or more images for the at least one trait; and
executing the script to identify the at least one trait in the two or more images.

12. The method of claim 8, further comprising:
generating a script to add the at least one rarity item to two or more images; and
executing the script to add the at least one rarity item to the two or more images.

13. The method of claim 8, further comprising:
creating the image based on an artwork being applied to a model of the at least one object.

14. The method of claim 8, wherein the at least one rarity item is related to the at least one object illustrated in the image.

15. A non-transitory computer-readable storage medium comprising: a set of instructions that, when executed by at least one processor, causes the at least one processor to perform operations for generating digital images containing rarity items, the operations comprising:
receiving, from a blockchain storage location, an image illustrating at least one object;
analyzing at least one trait of the image to determine the image meets a quality threshold;
in response to the image meeting the quality threshold, adding at least one rarity item to the image; and
storing metadata, associated with the image illustrating the at least one object and the at least one rarity item, in a non-fungible token (NFT) governed by a smart contract.

16. The non-transitory computer-readable storage medium of claim 15, wherein the operations further comprise:
collecting one or more features from the image;
comparing the one or more features to one or more attributes in the metadata associated with the image; and
in response to the one or more features matching the one or more attributes in the metadata, establishing authenticity that the image is related to the NFT governed by the smart contract.

17. The non-transitory computer-readable storage medium of claim 16, wherein the authenticity is established by at least one machine-learning algorithm, wherein the at least one machine-learning algorithm is trained based on at least one dataset associated with a previous image authenticity data source.

18. The non-transitory computer-readable storage medium of claim 15, wherein the operations further comprise:
generating a script to analyze two or more images for the at least one trait; and
executing the script to identify the at least one trait in the two or more images.

19. The non-transitory computer-readable storage medium of claim 15, wherein the operations further comprise:
generating a script to add the at least one rarity item to two or more images; and
executing the script to add the at least one rarity item to the two or more images, wherein the at least one rarity item is related to the at least one object illustrated in the image.

20. The non-transitory computer-readable storage medium of claim 15, wherein the operations further comprise:
creating the image based on an artwork being applied to a model of the at least one object.
